(19) United States
(12) Patent Application Publication
(10) Pub. No.: US 2025/0239635 A1
(43) Pub. Date: Jul. 24, 2025

(54) FUEL CELL SYSTEM

(71) Applicant: TOYOTA JIDOSHA KABUSHIKI KAISHA, Toyota-shi (JP)

(72) Inventors: Takahiro SAKAMOTO, Numazu-shi (JP); Masaaki MATSUSUE, Mishima-shi (JP); Kotaro IKEDA, Susono-shi (JP)

(21) Appl. No.: 18/969,456

(22) Filed: Dec. 5, 2024

(30) Foreign Application Priority Data
Jan. 18, 2024 (JP) 2024-006160

(51) Int. Cl. H01M 8/04746; H01M 8/04701

(52) U.S. Cl. CPC H01M 8/04753; H01M 8/04708

(57) ABSTRACT

A fuel cell system may include a fuel cell stack and a flow path configured to supply gas containing oxygen to the fuel cell stack, in which the flow path comprises a first component including a first outlet for the gas and a second component located downstream of the first component and including an inlet integrated with the first outlet without a piping between the inlet of the second component and the first outlet. The fuel cell system may further include a branch flow path configured to branch the gas from the flow path, in which the first component further comprises a second outlet for the gas, and the branch flow path may include a third component including an inlet integrated with the second outlet without a piping between the inlet of the third component and the second outlet.

### REFERENCE TO RELATED APPLICATIONS

This application claims priority to Japanese Patent Application No. 2024-6160, filed on Jan. 18, 2024, the entire contents of which are hereby incorporated by reference into the present application.

### BACKGROUND ART

The disclosure herewith relates to a fuel cell system.

Japanese Patent Application Publication No. 2013-4352 describes a fuel cell system in which an end plate at one end of the fuel cell stack is integrated with a stack case, an end plate at another end of the fuel cell stack is formed separately from the stack case and fixed to the stack case, and an auxiliary machine is attached to the other end plate.

### SUMMARY

According to Japanese Patent Application Publication No. 2013-4352, one of the end plates at both ends of the fuel cell stack in a cell stacking direction is integrated with the stack case to reduce the number of components and for downsizing. However, in fuel cell systems composed of various components including piping(s), further improvements in downsizing and reduction of the number of components has been desired.

A fuel cell system disclosed herein may comprise a fuel cell stack and a flow path configured to supply gas containing oxygen to the fuel cell stack. The flow path may comprise a first component including a first outlet for the gas and a second component located downstream of the first component and including an inlet integrated with the first outlet without a piping between the inlet of the second component and the first outlet.

According to the above configuration, in the flow path supplying the gas to the fuel cell stack, the first outlet of the first component and the inlet of the second component located downstream of the first component are integrated without a piping interposed between the first outlet and the inlet of the second component. Thus, further downsizing and a reduction in the number of components can be realized in the fuel cell system. In addition, such integration facilitates replacement work of components in the flow path.

### BRIEF DESCRIPTION OF DRAWINGS

FIG. 1 shows a simplified view of a portion of a fuel cell system according to a first embodiment.

FIG. 2 shows a simplified view of a portion of a fuel cell system according to a second embodiment.

FIG. 3 shows a simplified view of a portion of a fuel cell system according to a third embodiment.

FIG. 4 shows a simplified view of a portion of a fuel cell system according to a fourth embodiment.

FIG. 5 shows a simplified view of a portion of a conventional fuel cell system.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved fuel cell systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

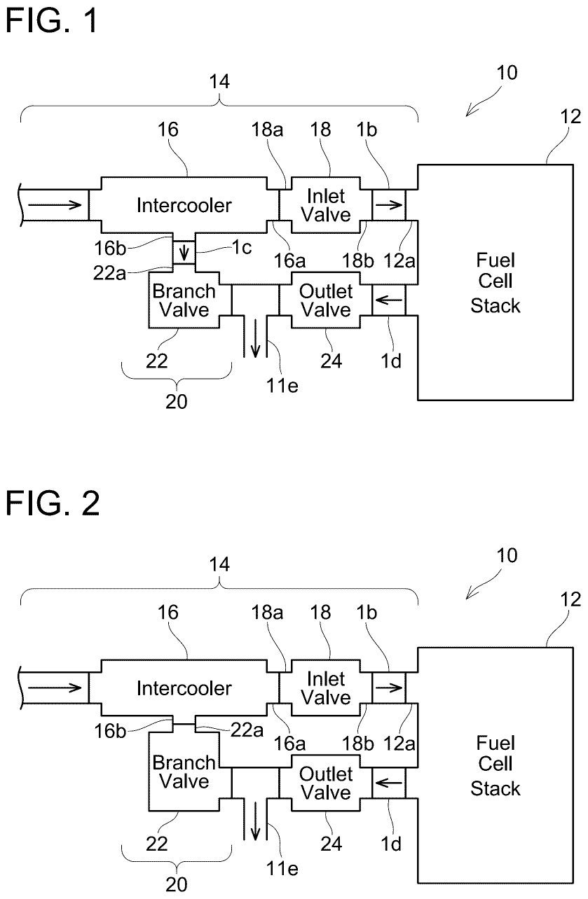

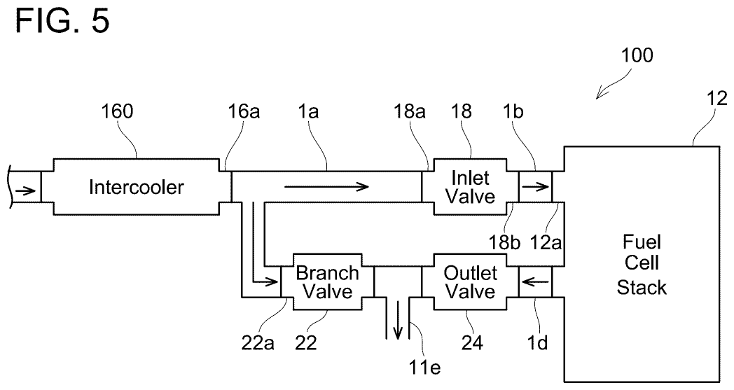

FIG. 1 shows a simplified view of a portion of a fuel cell system 10 according to a first embodiment included in aspects disclosed herein. FIG. 5 also shows a simplified view of a portion of a conventional fuel cell system 100. For the fuel cell system 100, configurations common to the fuel cell system 10 are marked with same symbols, and common explanations are omitted where appropriate. The fuel cell system 10 includes a fuel cell stack 12 and a first flow path 14 as a flow path for supplying gas containing oxygen to the fuel cell stack 12. Although a flow path for supplying hydrogen is naturally connected to the fuel cell stack 12, which generates electricity by reaction between hydrogen and oxygen, illustration of a system for supplying hydrogen to the fuel cell stack 12 is omitted. The fuel cell system 10 is installed in vehicles and other means of transportation, and may also be installed in factories, homes, etc.

The first flow path 14 includes an intercooler 16 and an inlet valve 18 located downstream of the intercooler 16. The intercooler 16 is an example of “first component” and the inlet valve 18 is an example of “second component”. The inlet valve 18, a branch valve 22, and an outlet valve 24, each of which will be described below, are examples of an electrically-operated valve. Each of the electrically-operated valves are configured to be controlled to be opened and closed and have degrees of opening and closing controlled by an unshown controller, and to adjust a flow rate of the gas to be passed therethrough.

An air compressor, not shown, is disposed upstream of the intercooler 16 in the first flow path 14. Gas compressed by the air compressor is supplied to the intercooler 16. The intercooler 16 cools the supplied gas and supplies it downstream. The intercooler 16 cools the gas by using, for example, cooling water. However, a cooling method by the intercooler 16 is not limited to any particular method. The intercooler 16 has a first outlet 16a for supplying the gas downstream. The inlet valve 18 has an inlet 18a for receiving the gas supplied from the intercooler 16. The inlet 18a of the inlet valve 18 will also be referred to as a first inlet 18a.

The inlet valve 18 has an outlet 18b for supplying the gas downstream. The outlet 18b of the inlet valve 18 will also be referred to as a third outlet 18b. According to FIG. 1, the third outlet 18b is connected to the fuel cell stack 12 via a piping 1b. Arrows in each piping indicate a direction of gas flow. The fuel cell stack 12 has an inlet 12a for receiving the gas supply from the inlet valve 18. The inlet 12a will also be referred to as a stack-side inlet 12a. The gas supplied from the intercooler 16 to the inlet valve 18 is supplied to the fuel cell stack 12 through the piping 1b.

According to FIG. 1, the intercooler 16 has a second outlet 16b for supplying the gas downstream. In the intercooler 16, the first outlet 16a is located downstream of the second outlet 16b. A branch flow path 20 is connected to the second outlet 16b for branching the gas from the first flow path 14. According to FIG. 1, the branch flow path 20 includes a piping 1c and the branch valve 22. The branch valve 22 is an example of “third component”. The branch valve 22 has an inlet 22a for receiving supply of the gas from the intercooler 16. The inlet 22a of the branch valve 22 will also be referred to as a second inlet 22a. According to FIG. 1, the second inlet 22a is connected to the second outlet 16b of the intercooler 16 via the piping 1c.

The fuel cell stack 12 is connected to a piping 1d at a different location than the stack-side inlet 12a. The piping 1d connects the fuel cell stack 12 to the outlet valve 24. The gas containing hydrogen is discharged from the fuel cell stack 12 to the outlet valve 24 through the piping 1d. A confluence piping 11e is connected to both a discharge side of the branch valve 22 and a discharge side of the outlet valve 24. At least a portion of the confluence piping 11e may be considered a part of the branch flow path 20.

The gas discharged from the intercooler 16 through the branch valve 22 and the gas containing hydrogen discharged from the fuel cell stack 12 through the outlet valve 24 are mixed in the confluence piping 11e. The gas mixed in the confluence piping 11e is then discharged to outside. Thus, the branch valve 22 has a function of adjusting a flow rate of the gas supplied from the intercooler 16 to the fuel cell stack 12 and diluting the hydrogen-containing gas discharged from the fuel cell stack 12 and discharging it to the outside.

According to the conventional configuration shown in FIG. 5, the first outlet 16a of the intercooler 160 and the first inlet 18a of the inlet valve 18 located downstream of the intercooler 160 were connected via a piping 1a. The piping 1a was branched midway and the branched end was connected to the second inlet 22a of the branch valve 22.

In contrast, in the first embodiment, the piping 1a is eliminated and the first outlet 16a of the intercooler 16 and the first inlet 18a of the inlet valve 18 are integrated as shown in FIG. 1. In other words, the first outlet 16a and the first inlet 18a are directly connected without a piping interposed between the first outlet 16a and the first inlet 18a. With the elimination of the piping 1a, in the first embodiment, the intercooler 16 has the second outlet 16b, and the second outlet 16b and the second inlet 22a of the branch valve 22 are connected by the piping 1c, which is shorter than the piping 1a.

FIG. 2 shows a simplified view of a portion of a fuel cell system 10 according to a second embodiment included in the aspects disclosed herein. Explanations of the second embodiment and third and fourth embodiments described below, which are common to the first embodiment, are omitted. As shown in FIG. 2, in the second embodiment, the second outlet 16b of the intercooler 16 and the second inlet 22a of the branch valve 22 are integrated without the piping 1c between the second outlet 16b and the second inlet 22a. In other words, in the second embodiment, in addition to the intercooler 16 and the inlet valve 18 being substantially integrated as in the first embodiment, the branch valve 22 is also substantially integrated with the intercooler 16 at a predetermined position.

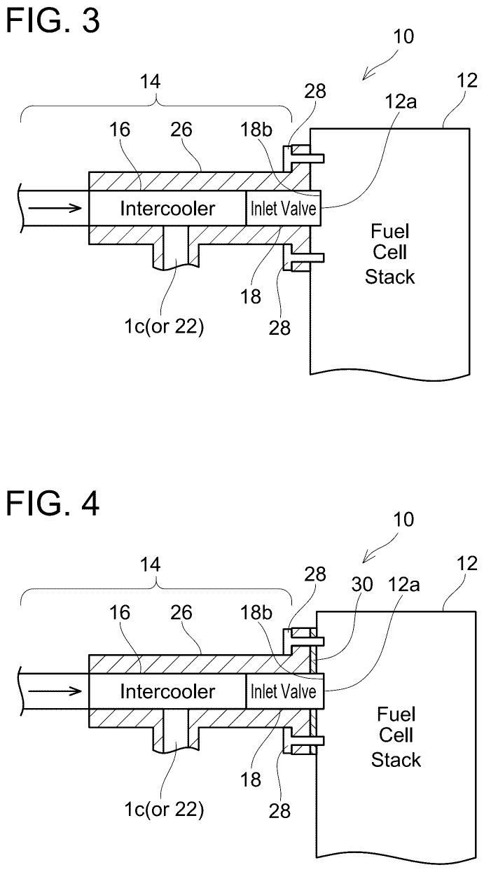

FIG. 3 shows a simplified view of a portion of a fuel cell system 10 according to a third embodiment included in the aspects disclosed herein. In FIG. 3, shapes of the intercooler 16, the inlet valve 18, and other parts are simplified than those in FIGS. 1 and 2. In addition, the outlet valve 24, the piping 1d, and the confluence piping 11e are omitted in FIG. 3. According to the third embodiment, as shown in FIG. 3, the third outlet 18b of the inlet valve 18 and the stack-side inlet 12a of the fuel cell stack 12 are integrated without the piping 1b between the third outlet 18b and the stack-side inlet 12a. In other words, in the third embodiment, the intercooler 16 and the inlet valve 18 are connected in series to the fuel cell stack 12 in this order without a piping between the intercooler 16 and the inlet valve 18.

In FIG. 3, a portion of the inlet valve 18 has been inserted into the fuel cell stack 12, but any specific form of integrating the third outlet 18b of the inlet valve 18 and the stack-side inlet 12a of the fuel cell stack 12 may be implemented. The fuel cell stack 12 has, generally, a cell stack composed of a plurality of stacked cells and a stack case that houses the cell stack and other components. Therefore, in the example of FIG. 3, the third outlet 18b may be understood to be directly connected to the stack-side inlet 12a formed in the stack case. On the other hand, in the examples of FIGS. 1 and 2, the piping 1b may be understood to be connected to the stack-side inlet 12a formed in the stack case.

According to FIG. 3, the intercooler 16 and the inlet valve 18 share a common casing 26. That is, the intercooler 16 and the inlet valve 18 are housed in a space within the casing 26 in a connected state. The casing 26 housing the intercooler 16 and the inlet valve 18 has a flanged portion on the fuel cell stack 12 side, and this flanged portion is fastened to the stack case of the fuel cell stack 12 with screws 28. As described in the first and second embodiments, the piping 1c or the branch valve 22 is connected to the intercooler 16 at a position upstream of the inlet valve 18. Therefore, as shown in FIG. 3, the casing 26 is shaped to also house at least a portion of the piping 1c or the branch valve 22 that is connected to the intercooler 16.

FIG. 4 shows a simplified view of a portion of a fuel cell system 10 according to a fourth embodiment included in the aspects disclosed herein. For FIG. 4, only points that differ from FIG. 3 will be described. The casing 26 may be assumed to be fixed to the fuel cell stack 12 via thermal insulation 30. According to FIG. 4, the thermal insulation 30 is sandwiched between the flanged portion of the casing 26 and a surface of the fuel cell stack 12. In FIGS. 3 and 4, the casing 26 and the thermal insulation 30 are shown by their cross-sectional shapes.

The intercooler 16, the inlet valve 18, and the branch valve 22 have been described above as examples of the first, second, and third components, but the first, second, and third components are not limited to these. The first, second, and third components may include any drive components or auxiliary equipment required in the flow path 14 configured to supply oxygen-containing gas to the fuel cell stack 12.

Thus, according to the present embodiment, the fuel cell system 10 comprises the fuel cell stack 12 and the first flow path 14 configured to supply gas containing oxygen to the fuel cell stack 12. The first flow path 14 comprises a first component including the first outlet 16a for the gas and a second component located downstream of the first component and including the first inlet 18a integrated with the first outlet 16a without a piping between the first outlet 16a and the first inlet 18a. According to the above configuration, further downsizing and a reduction in the number of components can be realized in the fuel cell system 10 due to the reduction of the piping 1a compared to the conventional fuel cell system 100. In addition, such integration facilitates replacement work of components in the first flow path 14 than conventional ones.

According to this embodiment, the fuel cell system 10 further comprises the branch flow path 20 configured to branch the gas from the first flow path 14. The first component may further comprise the second outlet 16b for the gas, and the branch flow path 20 may comprise a third component including the second inlet 22a integrated with the second outlet 16b without a piping between the second inlet 22a of the third component and the second outlet 16b. According to the above configuration, the reduction of the piping 1c in the branch flow path 20 relative to the first flow path 14 further facilitates the downsizing of the fuel cell system 10 and the reduction in the number of components.

According to this embodiment, the first component may be the intercooler 16 configured to cool the gas supplied from upstream of the first component, and each of the second component and the third component may be an electrically-operated valve. In the intercooler 16, the first outlet 16a may be located downstream of the second outlet 16b. According to the above configuration, by positioning the first outlet 16a downstream of the second outlet 16b in the intercooler 16, the gas supplied to the fuel cell stack 12 via the second component can be sufficiently cooled by the intercooler 16 before being supplied from the first outlet 16a.

According to this embodiment, the second component may further comprise the third outlet 18b for the gas, and the fuel cell stack 12 may comprise the stack-side inlet 12a integrated with the third outlet 18b of the second component without a piping between the stack-side inlet 12a of the fuel cell stack 12 and the third outlet 18b of the second component. According to the above configuration, the reduction of the piping 1b between the second component and the fuel cell stack 12 further facilitates the downsizing of the fuel cell system 10 and the reduction in the number of components.

According to this embodiment, the first component and the second component may share the common casing 26. The casing 26 may then be fixed to the fuel cell stack 12 via the thermal insulation 30. According to the above configuration, the first and second components are housed in the casing 26 as a single unit, which facilitates the installation and replacement of these components to the fuel cell stack 12. In addition, the thermal insulation 30 between the casing 26 and the fuel cell stack 12 can suppress heat from being conducted from the intercooler 16 to the fuel cell stack 12 through the casing 26.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A fuel cell system, comprising:
a fuel cell stack; and
a flow path configured to supply gas containing oxygen to the fuel cell stack, wherein the flow path comprises:
a first component including a first outlet for the gas; and
a second component located downstream of the first component and including an inlet integrated with the first outlet without a piping between the inlet of the second component and the first outlet.

2. The fuel cell system according to claim 1, further comprising a branch flow path configured to branch the gas from the flow path,
wherein the first component further comprises a second outlet for the gas, and
the branch flow path comprises a third component including an inlet integrated with the second outlet without a piping between the inlet of the third component and the second outlet.

3. The fuel cell system according to claim 2, wherein the first component is an intercooler configured to cool the gas supplied from upstream of the first component,
each of the second component and the third component is an electrically-operated valve, and
the first outlet is located downstream of the second outlet in the intercooler.

4. The fuel cell system according to claim 1, wherein the second component further comprises an outlet for the gas, and
the fuel cell stack comprises an inlet integrated with the outlet of the second component without a piping between the inlet of the fuel cell stack and the outlet of the second component.

5. The fuel cell system according to claim 4, wherein the first component and the second component share a casing, and
the casing is fixed to the fuel cell stack via thermal insulation.
